(19) United States
(12) Patent Application Publication
(10) Pub. No.: US 2002/0170855 A1
(43) Pub. Date: Nov. 21, 2002

(54) Pleated domed shaped extrusion pack

(76) Inventors: Fritz Robert Smith III, Victoria, TX (US); Fritz Robert Smith IV, Victoria, TX (US)

Correspondence Address: Fritz Robert Smith III, 3401 Houston Ave, Snyder, TX, 79549, US

(21) Appl. No.: 09/784,955

(22) Filed: May 15, 2001

(51) Int. Cl. B01D 27/06; B23P 15/16

(52) U.S. Cl. 210/489; 210/493.1; 210/499; 29/896.6

(57) ABSTRACT

A dome shaped filtering device for removal of contaminants from extrudate, consisting of a coarse mesh support screen, an intermediate mesh support screen and a fine mesh filter screen. All screens are stainless steel woven wire. A method and apparatus(s) for producing the screens is also included.

### FIELD OF THE INVENTION

The present invention relates to a filtering device suitable for the removal of contaminates from any extrudate.

### BACKGROUND OF THE INVENTION

Conventional screen packs fall in the categories of either flat, circular configuration, or, tubelike configuration.

Not only should the screen pack perform as a filter, but said filter should do its job efficiently.

The current screen packs are not only inefficient, but expensive as well.

The tube like extended area screen pack assembly must be removed from the machine and then each screen pack, as many as thirty (30), must be removed individually. The weight of this assembly is in excess of 100 (one hundred) lb., which far exceeds OSHA limits.

Other alternative screen packs, being one of flat circular design or conical design are severely limited in filtering area.

### OBJECT OF THE INVENTION

It is an object of the present invention to provide an economical alternative to existing types.

It is the object of the present invention to provide a more efficient screen pack.

It is an object of the present invention to provide an OSHA acceptable device

### BRIEF DESCRIPTIONS OF THE PHOTOGRAPHS/DRAWINGS FOR A SCREEN PACK DIAMETER OF TWELVE (12″) INCHES

FIG. 1 is a top view marking the screen to a major diameter of twenty and one-quarter (20.25″) inches and a minor diameter of eight (8) inches

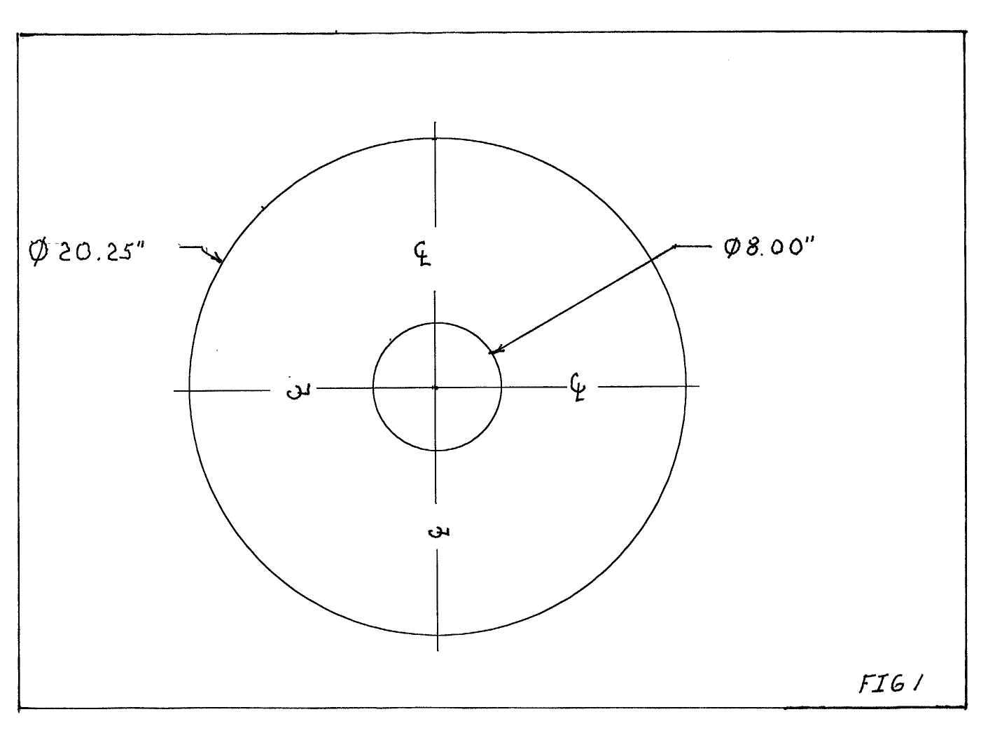

FIG. 1A is a top view dividing the screen in eight (8) equal parts by placing lines every forty-five (45) degrees along the circumference of the circle.

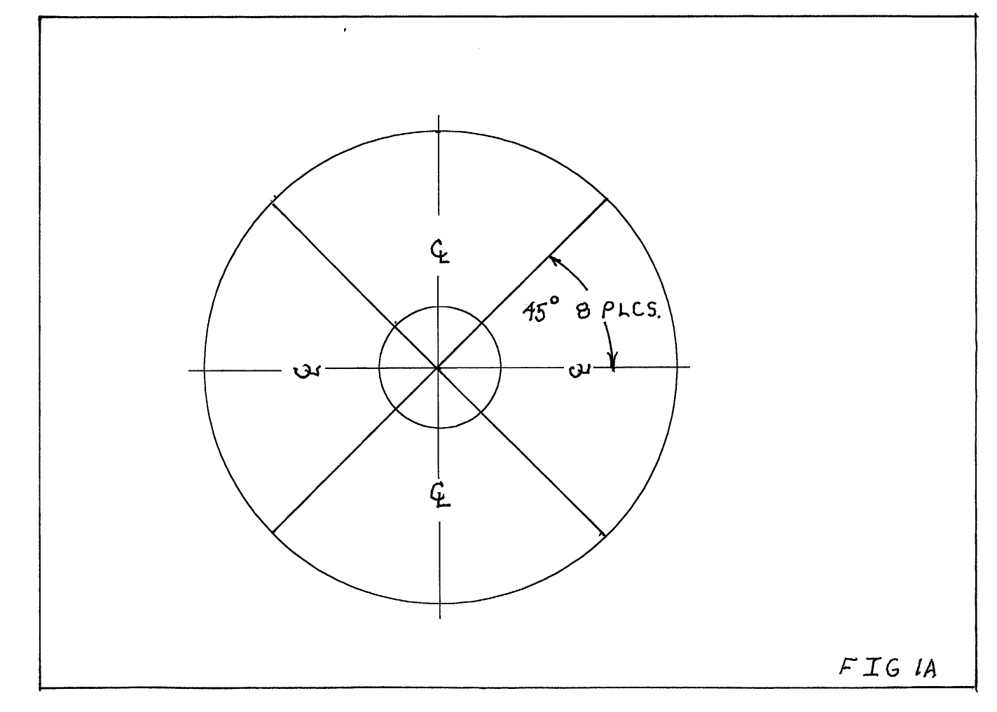

FIG. 1B is a top view of marking one and one half (1.5″) inches from each of the eight (8) divisional lines, in a counter clockwise direction, from their intersection with the major diameter circle.

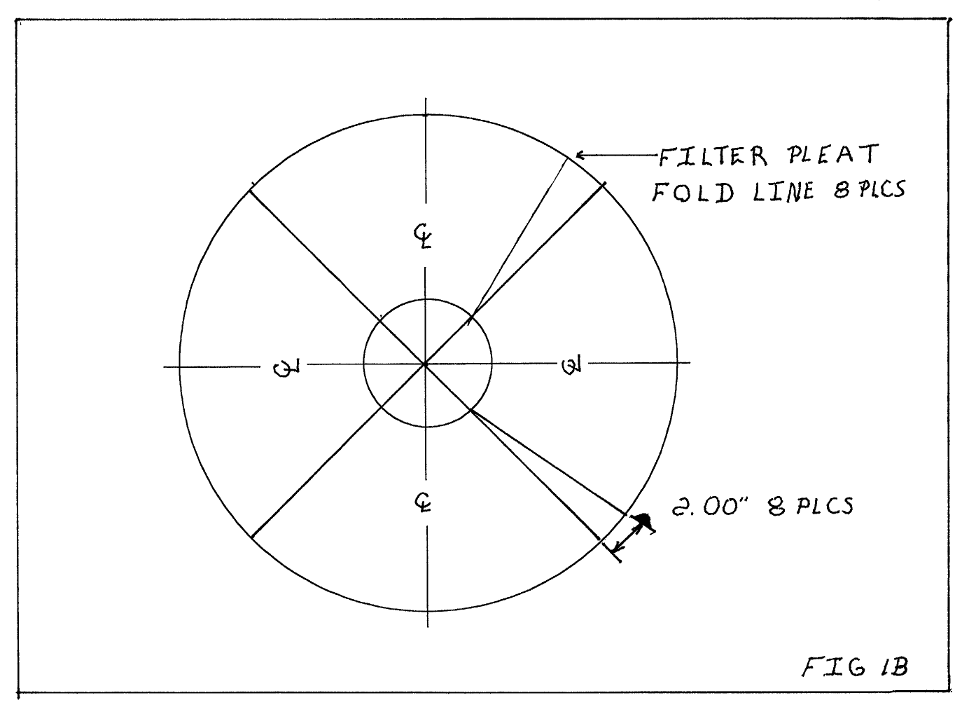

FIG. 2 is a top view layout of the coarse screen showing the major diameter of 20.25″ and the ghost circle of 5.50″.

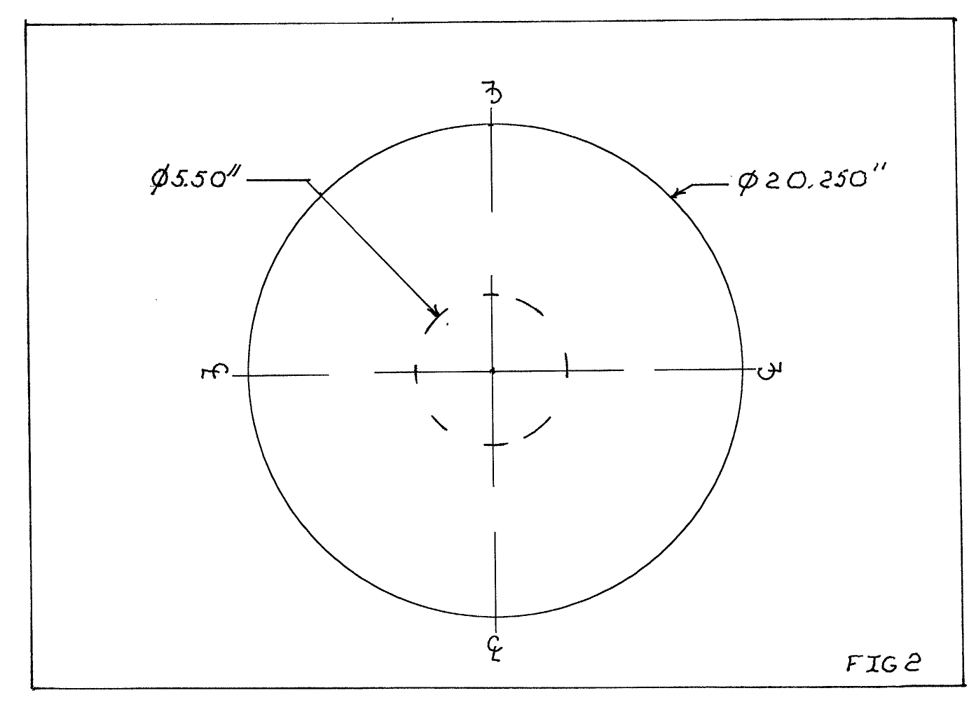

FIG. 2A is a top view layout of the coarse screen showing the 8 equal lines dividing the circle.

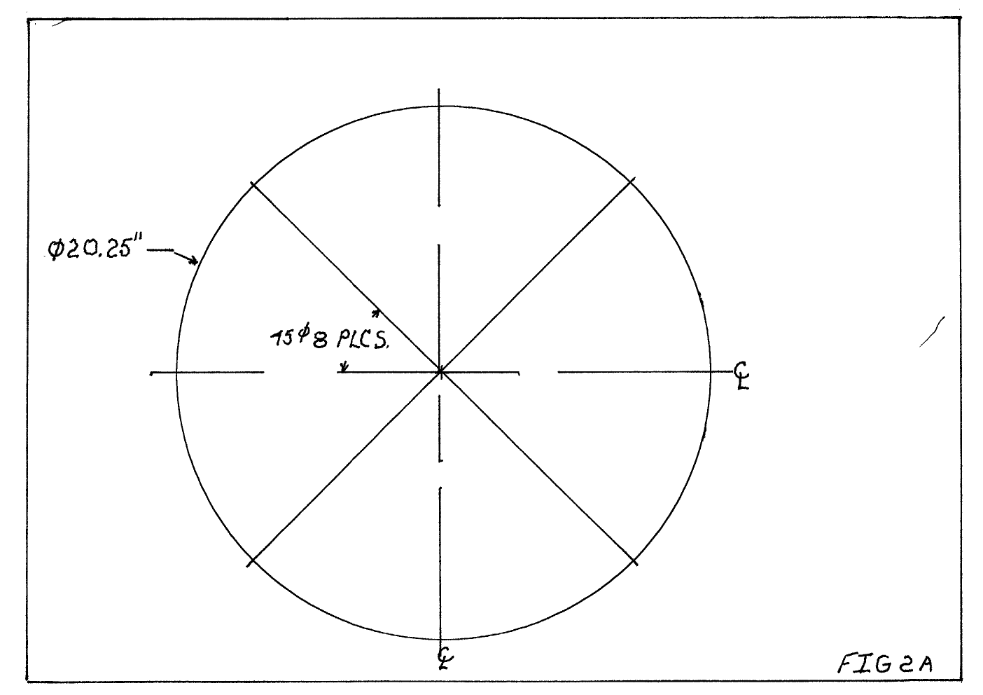

FIG. 2B is a top view depicting marking the eight (8) incision line arcs on the coarse support screen, each arc being 7.95″ in length and not to be cut beyond the distance as described by the ghost circle.

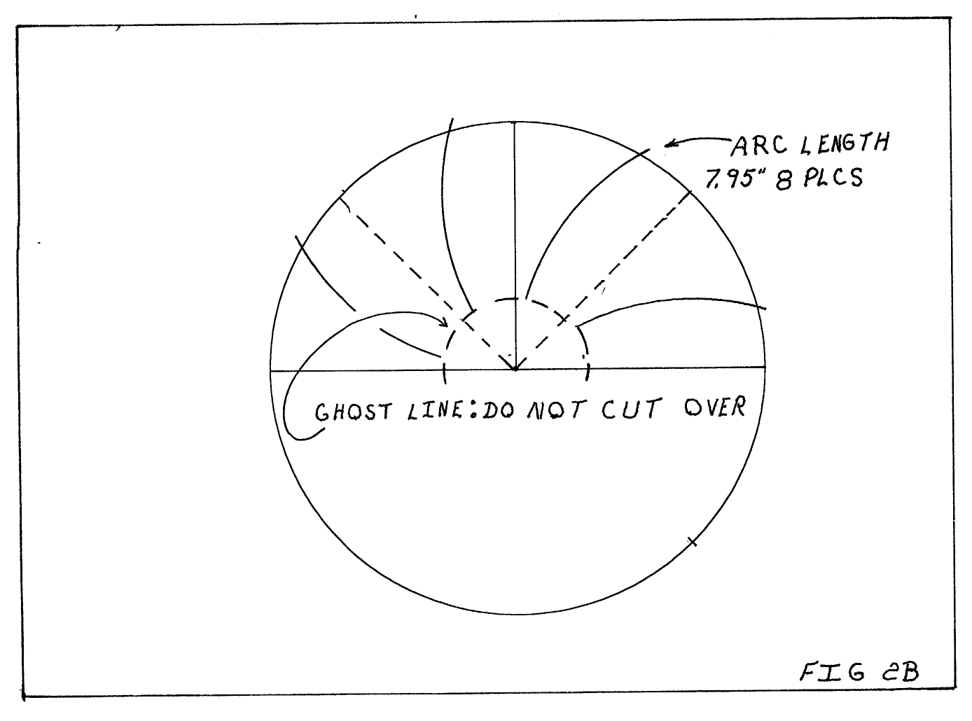

FIG. 3 is a photograph of the finished filter device as viewed from the product inlet side.

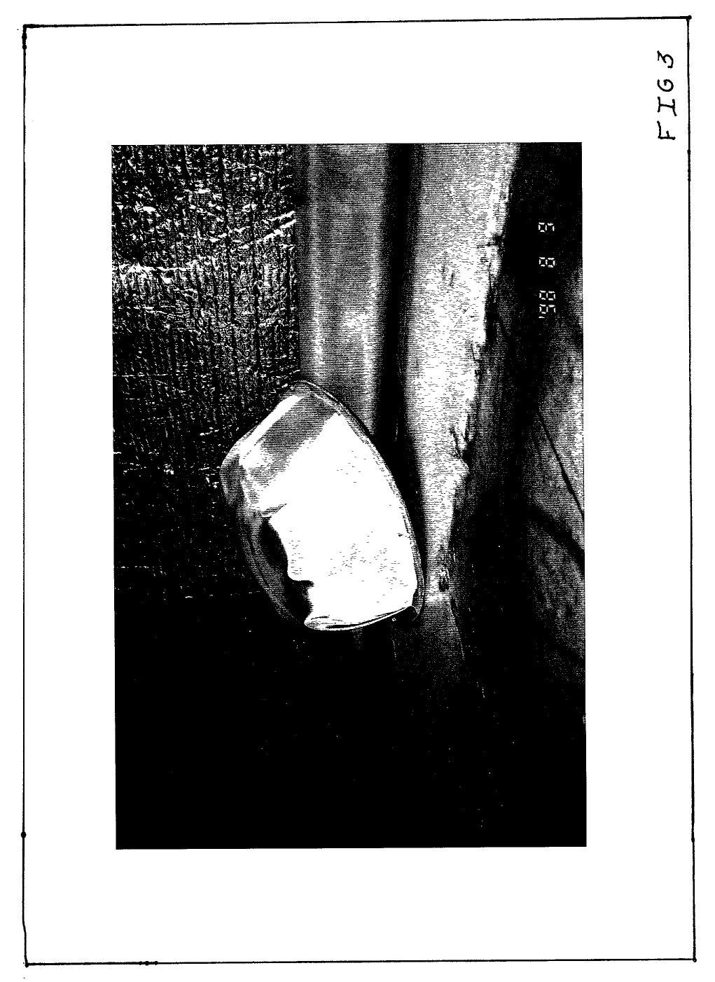

FIG. 3A is a photograph of the finished filter device as viewed from the product outlet side.

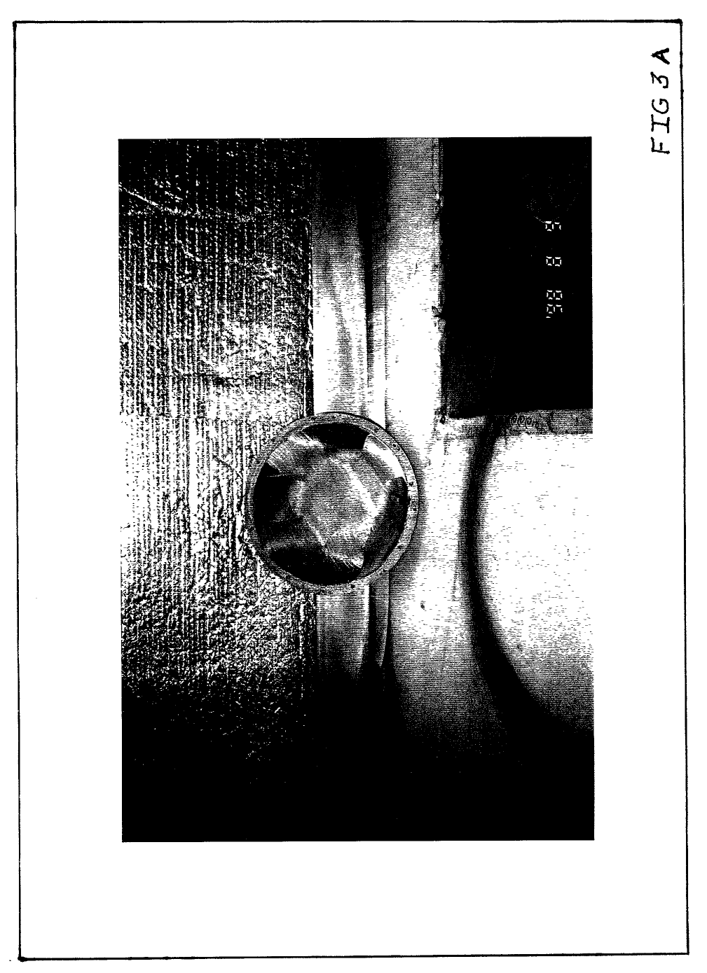

FIG. 4 is a photograph of the press apparatus, including the female and male molds.

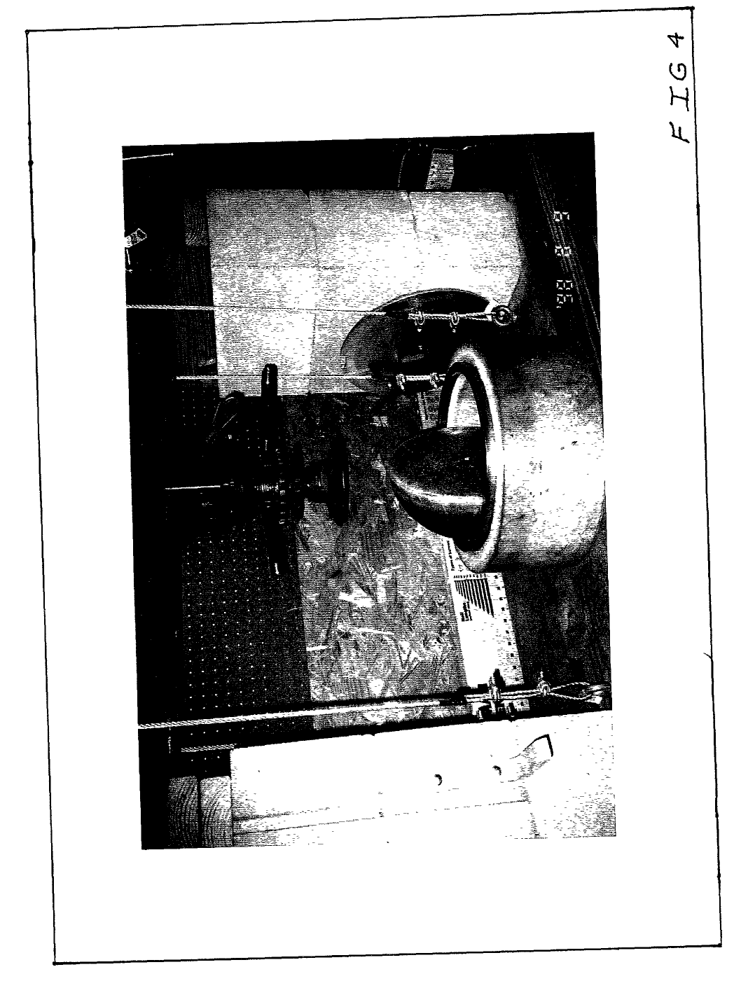

FIG. 5 is a photograph of the bolt circle jig.

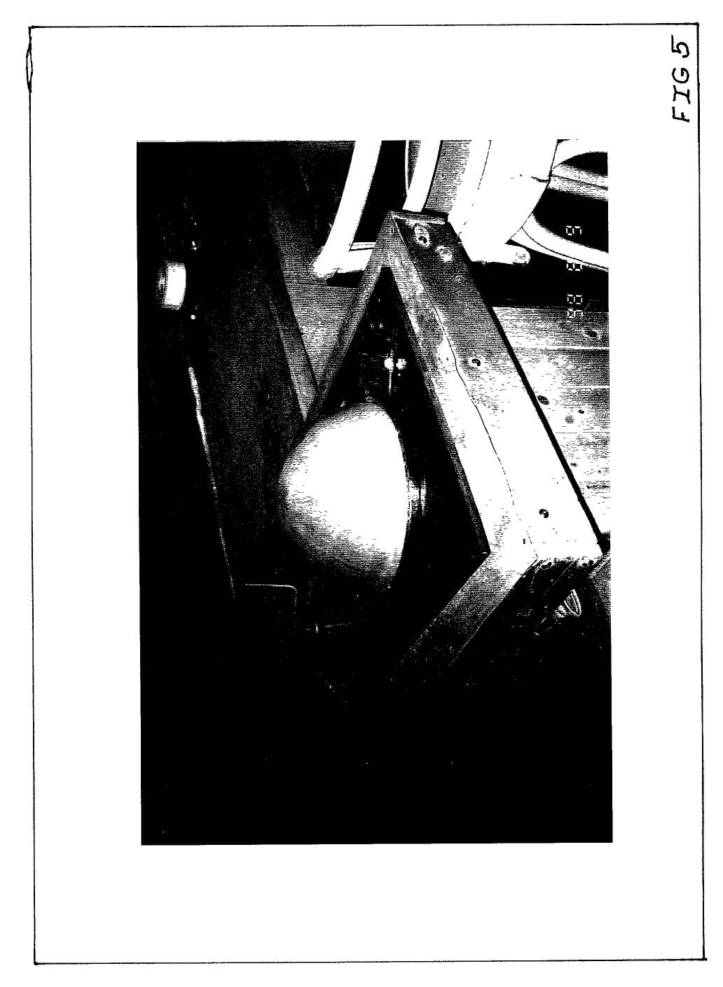

### SUMMARY

As noted the dome design, or any variation thereof permits increased surface area, further enhanced by adding the pleats.

Additionally, differential pressure of the present invention is far less than existing extended area designs simply due to the fact that the extrudate does not have to follow a tortuous route to pass through. This fact alone enhances machine efficiency by reducing the driver specific energy input.

The present invention, because of increased life and enhanced machine operation, equates to dollar savings to the end user.

Accordingly, what is claimed is

1. Dome shaped extruder screen pack, comprising: set of stainless steel filter screens; said filter screens consist of one (1) coarse mesh support screen, one (1) intermediate mesh support screen, and one (1) fine mesh filter screen. Said screen pack offering increased filtering area, thus increased filter life.

2. Screen pack of claim 1, wherein said screen pack can be fitted to any spherical shape and size.

3. Screen pack of claim 1, wherein said screen pack is a laminate.

4. Screen pack of claim 1, wherein said screen pack is pleated.

5. Screen pack of claim 1, said pleats could and do take any number, dependent upon the size and geometry of claim 1.

6. Screen pack of claim 1, said pleats can and do have two (2) distinct styles, pyramidal and mansard.

7. In a method of constructing a domed screen pack comprising: cut screens to prescribed diameter and fold for pleating, shape under pressure in a mold and spot weld for strength.

8. Method of claim 7, said step of cutting screen is determined by the size of the object to be covered.

9. Method of claim 7, said step of laying out the pleating folds.

10. Method of claim 7, said step of laying out the coarse mesh support screen incisions.

11. Method of claim 10, said step of forming said claim 10.

12. Method of claim 9, said step of forming said claim 9.

13. Method of claim 7, said screens are laminated, support mesh, intermediate mesh and fine mesh by spot welding said screens, one to the other.

14. Mold (female) and a dome shaped press (male) for final shaping of the finished product.

15. Jig for drilling the holes for the applied bolt circle.
